(19) United States
(12) Patent Application Publication
(10) Pub. No.: US 2018/0305860 A1
(43) Pub. Date: Oct. 25, 2018

(54) PATTERN COATED TEXTILE FOR ACTIVE COOLING

(71) Applicant: Milliken & Company, Spartanburg, SC (US)

(72) Inventors: Rajib Mondal, Greer, SC (US); Petr Valenta, Greer, SC (US); James A Rogers, Greenville, SC (US); James T. Greer, Chesnee, SC (US); Thomas C. Wiles, Easley, SC (US)

(21) Appl. No.: 15/891,486

(22) Filed: Feb. 8, 2018

Related U.S. Application Data
(60) Provisional application No. 62/489,777, filed on Apr. 25, 2017.

(51) Int. Cl. D06M 23/16; D06M 15/507; D06B 11/00; C01G 23/047

(52) U.S. Cl. CPC D06M 23/16; D06M 15/5075; D06B 11/00; D10B 2501/00; D10B 2331/04; D10B 2401/022; C01G 23/047

(57) ABSTRACT

A pattern coated textile containing a textile having an upper surface and a lower surface and comprising a plurality of yarns, where at least a portion of the yarns comprise a synthetic polymer and a patterned coating on at least the lower surface. The patterned coating covers between about 5 and 95% of the surface area of the lower surface of the textile and contains a functioned polyester selected from the group consisting of an ethoxylated polyester, a sulfonated polyester, an ethoxylated and sulfonated polyester, and mixtures thereof. The patterned coating also contains a binder and an optional dye.

### RELATED APPLICATIONS

This application claims priority to U.S. Provisional Patent Application 62/489,777, filed on Apr. 25, 2016, which is herein incorporated by reference in its entirety.

### TECHNICAL FIELD OF THE INVENTION

The present invention is directed towards pattern coated textiles for active cooling.

### BACKGROUND

A textile that is cool to touch and the cooling that is activated under high humidity condition (sweat activated cooling) is highly desirable for a wearer in a warmer environment or during exertion such as exercise. There is a need for an active cooling textile that provides sweat activated cooling.

### BRIEF SUMMARY OF THE INVENTION

A pattern coated textile containing a textile having an upper surface and a lower surface and comprising a plurality of yarns, where at least a portion of the yarns comprise a synthetic polymer and a patterned coating on at least the lower surface. The patterned coating covers between about 5 and 60% of the surface area of the lower surface of the textile and contains a functioned polyester selected from the group consisting of an ethoxylated polyester, a sulfonated polyester, an ethoxylated and sulfonated polyester, and mixtures thereof. The patterned coating also contains ceramic particles, a binder, and an optional dye.

### BRIEF DESCRIPTION OF THE DRAWINGS

FIG. 1 is a cross-sectional illustration of one embodiment of the invention.

FIG. 2 an illustration of one embodiment of the lower surface of the textile having a patterned coating thereon.

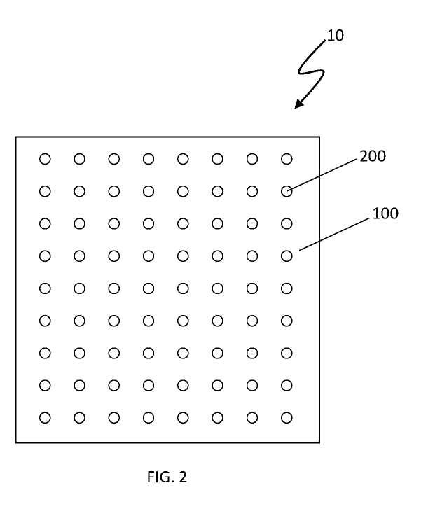

### DETAILED DESCRIPTION

A coating on the textile that is capable of cooling under a high humidity condition can be described as a sweat activated cooling textile. In order to achieve this cooling, materials can be coated onto the textile that are hydrophilic (have the affinity towards sweat) while also being hydrophobic to transfer or evaporate the sweat fast for efficient evaporative cooling. These two counterintuitive properties should be balanced for sustained evaporative cooling effect to have sustainable cooling as long as high humidity condition is available next to the skin. Textile finishes, such as ethoxylated polyesters for moisture wicking or transport are well known, but all those work when moisture is present in liquid form. It is more challenging to start the evaporative cooling in presence of high humidity (condition next to skin while body feels warm). A stronger hydrophilic group, such as sulfonic acid group increases the cooling effect.

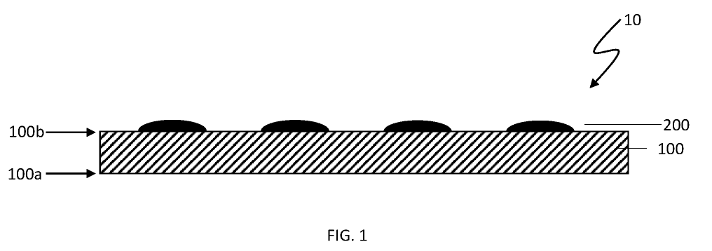

Referring to FIG. 1, there is shown one embodiment of the pattern coated textile 10. The pattern coated textile 10 contains a textile 100 and a patterned coating 200. The textile 100 has an upper surface 100a and a lower surface 100b. The patterned coating 200 is preferably applied on the lower surface 100b of the textile 100 and when made into a garment, the pattern coated textile 10 is preferably oriented such that the pattern coated side (lower surface 100b of textile 100) faces the wearer. In another embodiment, both surfaces (100a, 100b) have a patterned coating applied to them. In one preferred embodiment, the upper surface 100a comprises essentially no patterned coating. “Essentially no” in this measure means that less than about 2% of the surface area contains the functioned polyester coating.

The textile 100 may be any suitable textile such as a woven, knit, or non-woven. In one embodiment, the textile 100 is a woven textile. The weave may be, for example, plain, satin, twill, basket, poplin, jacquard, or crepe. Suitable plain weaves include, but are not limited to, rip stop weaves produced by incorporating, at regular intervals, extra yarns or reinforcement yarns in the warp, fill, or both the warp and fill of the textile material during formation. Suitable twill weaves include both warp-faced and fill-faced twill weaves, such as 2/1, 3/1, 3/2, 4/1, 1/2, 1/3, or 1/4 twill weaves. In certain embodiments of the invention, such as when the textile material is formed from two or more pluralities or different types of yarns, the yarns are disposed in a pattern-wise arrangement in which one of the yarns is predominantly disposed on one surface of the textile material. In other words, one surface of the textile material is predominantly formed by one yarn type. Suitable pattern-wise arrangements or constructions that provide such a textile material include, but are not limited to, satin weaves, sateen weaves, and twill weaves in which, on a single surface of the textile, the fill yarn floats and the warp yarn floats are of different lengths. Preferably, the textile 100 is a twill woven textile.

In another embodiment, the textile 100 is a knit textile, for example a circular knit, reverse plaited circular knit, double knit, single jersey knit, two-end fleece knit, three-end fleece knit, terry knit or double loop knit, weft inserted warp knit, warp knit, and warp knit with or without a micro-denier face.

In another embodiment, the textile 100 is a multi-axial, such as a tri-axial textile (knit, woven, or non-woven). In another embodiment, the textile 100 is a bias textile.

In another embodiment, the textile 100 is a non-woven textile. The term “non-woven” refers to structures incorporating a mass of yarns or fibers that are entangled and/or heat fused so as to provide a coordinated structure with a degree of internal coherency. Non-woven textiles may be formed from many processes such as for example, meltspun processes, hydroentangeling processes, mechanically entangled processes, stitch-bonding processes and the like.

The textile 100 contains any suitable yarns. “Yarn”, in this application, as used herein includes a monofilament elongated body, a multifilament elongated body, ribbon, strip, yarn, tape, fiber and the like. The textile 100 may contain one type of yarn or a plurality of any one or combination of the above. The yarns may be of any suitable form such as spun staple yarn, monofilament, or multifilament, single component, bi-component, or multi-component, and have any suitable cross-section shape such as circular, multi-lobal, square or rectangular (tape), and oval.

The textile 100 can be formed from a single plurality or type of yarn (e.g., the textile can be formed solely from polyester yarns), or the textile can be formed from several pluralities or different types of yarns (e.g., the textile can be formed from a cotton and polyester yarns). Each yarn may contain one material (such as cotton) or may be a mixture of materials (such as nylon/cotton blends). Preferably, at least a portion of the yarns contain a synthetic polymer (aka one that is man-made and not naturally formed). In one preferred embodiment, at least a portion of the yarns of the textile layer 100 comprise polyester. Polyester yarns are preferred as the polyester part of the sulfonated and ethoxylated polyesters interact with the polyester yarn and provides wash durability to the printed materials.

The polyester yarns can be present in the textile 100 in any suitable amount. For example, in certain embodiments, the polyester yarns can comprise about 15% or more, about 20% or more, about 25% or more, about 30% or more, or about 35% or more, by weight, of the yarns present in the textile. In another embodiment, the polyester yarns can comprise about 95% or less or about 90% or less, by weight, of the yarns present in the textile 100. More specifically, in certain embodiments, the polyester yarns can comprise about 15% to about 95%, about 20% to about 95%, about 25% to about 95%, about 30% to about 95%, or about 30% to about 90%, by weight, of the yarns present in the textile 100.

Additional yarns may include, but are not limited to, nylon, SPANDEX© (or other elastic fibers), NOMEX©, cellulosic yarns (derived from cellulose including cotton, rayon, linen, jute, hemp, cellulose acetate, and combinations, mixtures, or blends thereof). The textile 100 may contain additional thermoplastic synthetic fibers. Suitable thermoplastic synthetic fibers include, but are not necessarily limited to, poly(propylene terephthalate) fibers, poly(trimethylene terephthalate) fibers), poly(butylene terephthalate) fibers, and blends thereof), polyamide fibers (e.g., nylon 6 fibers, nylon 6,6 fibers, nylon 4,6 fibers, and nylon 12 fibers), polyvinyl alcohol fibers, an elastic polyester-polyurethane copolymer (SPANDEX©), flame-resistant meta-aramid (NOMEX©) and combinations, mixtures, or blends thereof.

Preferably, the textile 100 contains polyester and cotton yarns and is in a construction such that the upper surface 100a of the textile is rich in cotton and the lower surface 100b of the textile is rich in polyester. Preferably, the textile 100 is a twill weave textile with the majority of the upper surface 100a of the textile formed by cotton yarns and the majority of the lower surface 100b of the textile formed by polyester yarns.

Referring back to FIG. 1, the patterned coating covers between about 5 and 60% of the surface area of the lower surface 100b of the textile 100 and contains a functioned polyester selected from the group consisting of an ethoxylated polyester, a sulfonated polyester, an ethoxylated and sulfonated polyester, and mixtures thereof, ceramic particles, a binder, and an optional dye. More preferably, the patterned coating covers between about 10 and 30% of the surface area of the lower surface 100b of the textile 100. In another embodiment, the patterned coating covers between about 5 and 95% of the surface area of the lower surface 100b of the textile 100, more preferably between about 5 and 80%, more preferably between about 5 and 70%.

In one embodiment, the functioned polyester comprises an ethoxylated polyester. In one embodiment, the functioned polyester comprises a sulfonated polyester. In one embodiment, the functioned polyester comprises a physical blend of an ethoxylated polyester and a sulfonated polyester ethoxylated polyester. In another embodiment, the functioned polyester comprises an ethoxylated and sulfonated polyester. Preferably, the patterned coating contains ethoxylated and sulfonated polyester.

Ethoxylated and sulfonated polyester can be either a block or random polymer of any molecular weight. The polymer can consist of but not limited to ethanolamine, ethylene glycol, 1,2-propylene glycol, 1,3-propanediol, neopentyl glycol, glycerol, 1,2 butylene glycol, 1,4-butanediol, 2,2-dimethyl-1,3-propanediol, 1,6-hexanediol, 1,4-cyclohexanedimethanol, terephthalic, isophthalic, orthophthalic, 1,2-naphthalene dicarboxylic, 1,4-naphthalenedicarboxylic, 1,5-naphthalenedicarboxylic, 1,6-naphthalenedicarboxylic, 1,7-naphthalenedecarboxylic, 1,8-naphthalenedicarboxylic, 2,3-naphthalenedicarboxylic, 2,6-naphthalenedicarboxylic, 2,7-naphthalenedicarboxylic acids and their corresponding alkyl esters, dimethyl-5-sodiosulfoterephthalate, 5-sodiosulfoisophthalic acid, 5-lithoisophthalic acid, 3-sodiosulfobenzoic acid, 4-sodiosulfo-2,2-naphthalenedicarboxylic acid, and 4-sodiosulfddiphenyl-4,4′-dicarboxylic acid.

Functioned polyester selected from the group consisting of an ethoxylated polyester, a sulfonated polyester, an ethoxylated and sulfonated polyester, and mixtures thereof

Part of the ethoxylated and sulfonated polyester contains the following formula: [(OCH₂CH₂)ₙOC(═O)—R—C(═O)—] wherein n is 1 or higher and R is aryl group or alkyl group, which could be functionalized with —SO₃X (X is a cation).

The patterned coating also contains ceramic particles. Ceramic is solid material containing either metal or non-metal complexes. Ceramics are usually higher in density (density greater than 3 g/cm³) and high thermal conductivity (thermal conductivity >8 W/(m·K)). In the current invention, ceramic materials have been added to the coating formulation to achieve fast dissipation and distribution of the absorbed heat from the coating. In addition, ceramic particles also enhance the maximum heat loss that can occur when the skin touching objects or other materials. Preferably, the ceramic particles have a density of between about 3 and 5 g/cm³, more preferably between about 3.5 and 4.5 g/cm³. The ceramic particles preferably have a mean diameter of between about 50 and 300 nanometers. In one preferred embodiment, the ceramic particles contain titanium dioxide which is preferred because of its high density and relatively low cost.

A high density material with high thermal conductivity will lead to fast dissipation and distribution of the absorbed heat from the coating. Ceramics are usually higher in density (density greater than 3 g/cm³) and high thermal conductivity (thermal conductivity >8 W/(m·K)). In the current invention, ceramic materials have been added to the coating formulation to achieve the above mentioned properties. In addition, ceramic particles also enhance the maximum heat loss that can occur when the skin touching objects or other materials.

The patterned coating 200 can be in any suitable pattern. The patterned coating 200 may be continuous or discontinuous, regular and repeating or random. “Continuous” in this application means that from one edge of the textile to the other edge there is a path that contains the patterned coating and that at least some of the patterned coating areas are connected. Examples of continuous coatings include straight lines and a grid. “Discontinuous” in this application means that the patterned coated areas are discontinuous and not touching one another. In a discontinuous patterned coating, there is no path from one edge of the fabric to the other that contains the patterned coating. Examples of discontinuous coatings include dots. Regular or repeating patterns mean that the pattern has a repeating structure to it. The pattern may also be a random pattern where there is no repeat to the patterned coating. In a random pattern, it is preferred that the random pattern is also discontinuous, not continuous. The patterned coating 200 may take any patterned form including but not limited to indicia, geometric shapes or patterns, lines (straight and curved), grids, and text.

Preferably, the patterned coating is in a dot pattern. This pattern is discontinuous and repeating. The dots may be equally spaced on the fabric, or may have differing densities of dots or sizing of dots across the surface of the fabric. For the same % of surface covered, smaller dots on a higher frequency or larger dots on a lower frequency may be used. Preferably, the dots have an average diameter of between about 2 and 8 millimeters.

The patterned coating may contain any suitable additives. For example, the patterned coating 200 contains a binder to help the stability of the patterned coating and the application of the patterned coating 200 onto the textile 100. Preferably, the binder contains polyurethane and/or acrylic. The pattern coating also optionally comprises a dye. This dye makes it easier to distinguish the coated side versus the uncoated side of the textile 100, evaluate the coating quality of the patterned coating 200, and is a visual indication of the patterned coating for the consumer.

Other optional additives include, but are not limited to, fillers, stabilizers, plasticizers, tackifiers, flow control agents, cure rate retarders, adhesion promoter), adjuvants, impact modifiers, expandable microspheres, thermally conductive particles, electrically conductive particles, silica, glass, clay, talc, pigments, colorants, glass beads or bubbles, antioxidants, optical brighteners, antimicrobial agents, surfactants, fire retardants, and fluoropolymers.

After the patterned coating is applied to the textile and dried, the patterned coating (dried) preferably contains between about 0.2 and 10% by weight of the functionalized polyester and between about 0.01 and 10% by weight of ceramic particles.

Although sulfonated polyester derivative was used as an example in this invention, other hydrophilic groups in polyester would work at different extent based on their hydrophilicity. For example, hydroxyl (—OH), carboxylic acid (—COOH), amine (—NH₂), phosphonic acid (—PO(OH)₂) groups on a polyester backbone. The degree of functionalization (ratio of hydrophilic groups vs polyester backbone) can be varied to enhance the functionalization. It also can be multiple groups in one polymer backbone.

The patterned coating 200 may be formed by any known method of forming a patterned coating including but not limited to inkjet printing, gravure printing, patterned printing, thermal transfer, spray coating, and silk printing. The thickness and/or physical composition of the patterned coating 200 may vary over the length and/or width of the textile 200. For example, it may be preferred in some embodiments to have a thicker coating or more densely packed pattern in some areas of the textile.

In one embodiment, the patterned coating 200 has a weight of between about 0.5 and 10% by weight of the total pattern coated textile 10, more preferably, the patterned coating 200 has a weight of less than 5% by weight of the total pattern coated textile 10.

The patterned coating is preferably more hydrophilic than the textile. This facilitates the wicking of the moisture from the wearer's skin into the garment.

In one embodiment, the pattern coated textile 10 is made into an article of clothing. The article of clothing is preferably made such that the lower surface 100b of the textile 100 (the surface with the patterned coating) faces the wearer and forms the innermost surface of the article of clothing.

This article of clothing may be any suitable article but is preferably an article of clothing that is worn next to the wearer (so preferably a shirt versus a coat). The mechanisms of the cooling work more efficiently when the article of clothing is in direct contact with the skin of the wearer. The article of clothing could be, for example, a short, pair of pants, tights, jacket, socks, hat, or undergarments.

In another embodiment, a garment may use the pattern coated textile in addition to other textile. For example, a shirt might use the pattern coated textile on the torso and another textile in the sleeves. Additionally, the pattern coated textile could also be used as an insert.

### Test Methods

Weight of the textile was measured using ASTM D 3776. Air permeability was measured using ASTM D 737. Water Vapor Transmission of Materials (MVTR) was measured ASTM E 96-95: Water Vapor Transmission of Materials, modified procedure B; Open Jar Method. Q-Max is the measurement of the maximum heat loss that can occur when the skin touching objects or other materials. Larger Q-max, cooler the material, in this case textile, to human touch. The Kawabata thermal tester (Thermolabo) is used to measure the Q-max.

To determine the sweat activated cooling, fabric was first exposed to the steam from the water kept ˜60-70° C. for 1-2 minutes. Fabric was then transferred to a stage where the FLIR E60 thermal imaging camera was set up at 15 inch height from the sample.

### EXAMPLES

### Pattern Coating Formulation

The functionalized polyester used was HYDROPERM® HPA liq available from Clariant which is an ethoxylated and sulfonated polyester. To the desired amount of HYDROPERM®, water dispersible dye, binder (SERABINDER® MHF available from Dystar), and ceramic particles are first added. After vigorous stirring, a viscosity modifier (SERAPRINT® M-PHC available from Dystar) was slowly added while kept on stirring until viscosity of >10,000 cps was achieved. White ME 24-R is titanium dioxide (TiO₂) particles having ˜50% of solid content with viscosity of 20-25000 cps with pH in the range of 9.5-10.5. In one embodiment, formulation in the table below could be used. Viscosity of this formulation was 12,500 cps.

| | | |
|---|---|---|
| Functioned polyester | HYDROPERM ® HPA liq | 89 kg |
| Dye | Imperon Yellow K-3G | 1 kg |
| Ceramic particles | White ME 24-R | 5 kg |
| Binder | SERABINDER ® MHF | 5 kg |
| Viscosity modifier | SERAPRINT ® M PHC | 2.5 kg |

### Example 1

Example 1 was a 7.6 ounces per square yard (osy) twill woven fabric with 80/20 polyester/cotton content dyed in khaki color. 65/35 polyester/cotton intimately blended yarns were used as warp and 100% polyester was used as fill yarn. The lower surface of the fabric (printed side of the fabric) was polyester rich and face of the fabric was cotton rich. After the fabric was made, it was treated with typical durable press resin and wicking finishes (for wrinkle resistance and moisture transport). Example 1 was not pattern coated.

### Example 2

Example 2 used the textile as described in Example 1. The lower surface of the textile was printed using 80 mesh polka dot screen at a printing range using the pattern coating formulation. The printed dot size was approximately 3 mm. A 55 mm blade was used to generate the pressure during printing. The printed pattern was cured in tenter frame running at speed of 20 yards per minute (ypm) and temperature set at 360° F. The printed dot pattern covered approximately 17% of the lower surface of the textile and the weight gain after drying the coating was approximately 1%.

### Example 3

Example 3 used the textile as described in Example 1. The lower surface of the textile was printed using 80 mesh polka dot screen at a printing range using the pattern coating formulation. The dot size was approximately 5 mm. A 55 mm blade was used to generate the pressure during printing. The printed pattern was cured in tenter frame running at speed of 20 ypm and temperature set at 360° F. The printed dot pattern covered approximately 13% of the lower surface of the textile and the weight gain after drying the coating was approximately 0.6%.

| | % lower surface | | Osy of | | | |
|---|---|---|---|---|---|---|
| | covered | | printed | Q-max | Q-max | |
| | by | Air | and | (printed | (upper | |
| | patterned | permeability | dried | side) | surface) | MVTR |
| | coating | (cfm) | textile | (watts/cm²) | (watts/cm²) | (g/m²/24 hr) |
| Ex. 1 | 0% | 6.84 | 7.63 | 0.149 | 0.142 | 861 |
| Ex. 2 | 17% | 5.15 | 7.70 | 0.152 | 0.139 | 867 |
| Ex. 3 | 13% | 5.32 | 7.66 | 0.169 | 0.139 | 872 |

Higher the Q-max, cooler it feels to touch. Typical fabric (without any durable press resin or wicking treatment) made from cotton and polyester has Q-max value of around 0.1 watts/cm². Q-max is significantly improved to 0.149 watts/cm² on the Ex. 1 textile after permanent press resin and wicking chemistry padding. The Q-max was further improved by ˜15% upon printing the patterned coating (Ex. 2 and 3) as it is shown in the Table above. While weight gain of the fabric due to the patterned printing is insignificant, MVTR has improved. This effect has been found to be wash durable having been tested through 100 industrial laundry cycles.

The Examples were subjected to steam and a thermal imaging camera was used to measure the temperature difference between the printed dots and the surrounding (unprinted) fabric. The printed spots were measured to be approximately 2.0-3.3° F. cooling than the surrounding fabric. This indicates the sweat activated cooling properties of the printed dots.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

What is claimed is:

1. A pattern coated textile comprising:
a textile having an upper surface and a lower surface and comprising a plurality of yarns, wherein at least a portion of the yarns comprise a synthetic polymer;
a patterned coating on at least the lower surface, wherein the patterned coating covers between about 5 and 60% of the surface area of the lower surface of the textile and comprises a functioned polyester selected from the group consisting of an ethoxylated polyester, a sulfonated polyester, an ethoxylated and sulfonated polyester, and mixtures thereof, ceramic particles, a binder, and an optional dye.

2. The pattern coated textile of claim 1, wherein the synthetic polymer is polyester.

3. The pattern coated textile of claim 1, wherein the functioned polyester comprises an ethoxylated polyester.

4. The pattern coated textile of claim 1, wherein the functioned polyester comprises an ethoxylated and sulfonated polyester.

5. The pattern coated textile of claim 1, wherein a majority of lower surface of the textile comprises polyester yarns.

6. The pattern coated textile of claim 1, wherein the ceramic particles comprise titanium dioxide.

7. The pattern coated textile of claim 1, wherein the ceramic particles have a mean diameter of between about 50 and 300 nanometers.

8. The pattern coated textile of claim 1, wherein the patterned coating is a discontinuous pattern.

9. The pattern coated textile of claim 1, wherein the patterned coating is a continuous pattern.

10. The pattern coated textile of claim 1, wherein the patterned coating comprises indicia.

11. An article of clothing comprising the patterned coated textile of claim 1, wherein the pattern coated textile is oriented such that the patterned coating faces a wearer of the article of clothing.

12. A pattern coated textile comprising:
a textile having an upper surface and a lower surface and comprising a plurality of yarns, wherein at least a portion of the yarns comprise a synthetic polymer;
a patterned coating on the lower surface, wherein the patterned coating covers between about 5 and 60% of the surface area of the lower surface of the textile and less than about 2% of the surface area of the upper surface of the textile,
wherein the patterned coating comprises a functioned polyester selected from the group consisting of an ethoxylated polyester, a sulfonated polyester, an ethoxylated and sulfonated polyester, and mixtures thereof, ceramic particles, a binder, and an optional dye,
wherein the ceramic particles comprise titanium dioxide, have a density of between about 3 and 4.5 g/cm³, and have a mean diameter of between about 50 and 300 nanometers,
wherein the pattern coated textile comprises between about 0.5 and 10% by weight pattern coating, wherein the patterned coating comprises between about 0.2 and 10% by weight of the functionalized polyester and, wherein the patterned coating comprises between about 0.01 and 10% by weight of ceramic particles.

13. The pattern coated textile of claim 12, wherein the synthetic polymer is polyester.

14. The pattern coated textile of claim 12, wherein the functioned polyester comprises an ethoxylated polyester.

15. The pattern coated textile of claim 12, wherein the functioned polyester comprises a sulfonated polyester.

16. The pattern coated textile of claim 12, wherein the functioned polyester comprises a physical blend of an ethoxylated polyester and a sulfonated polyester.

17. The pattern coated textile of claim 12, wherein the functioned polyester comprises an ethoxylated and sulfonated polyester.

18. The pattern coated textile of claim 12, wherein a majority of lower surface of the textile comprises polyester yarns.

19. The pattern coated textile of claim 12, wherein the patterned coating is a discontinuous pattern.

20. The pattern coated textile of claim 12, wherein the patterned coating is a continuous pattern.

21. The pattern coated textile of claim 12, wherein the patterned coating comprises indicia.

22. An article of clothing comprising the patterned coated textile of claim 12, wherein the pattern coated textile is oriented such that the patterned coating faces a wearer of the article of clothing.
